(19) United States
(12) Patent Application Publication
(10) Pub. No.: US 2014/0104992 A1
(43) Pub. Date: Apr. 17, 2014

(54) WATCH DEVICE WITH EVENT PLANNING ELEMENTS

(71) Applicant: Gilbert Villareal, Oakland Township, MI (US)

(72) Inventor: Gilbert Villareal, Oakland Township, MI (US)

(21) Appl. No.: 14/046,992

(22) Filed: Oct. 6, 2013

Related U.S. Application Data
(60) Provisional application No. 61/795,361, filed on Oct. 15, 2012.

(51) Int. Cl. G04B 19/247

(52) U.S. Cl. CPC G04B 19/247
USPC 368/37

(57) ABSTRACT

A watch of the present invention includes a calendar date finder in the form of two interacting disks rotatable relative to the other thereby providing calendar date information. A first disk has a circular periphery with a numeric indicia printed thereon. The numeric indicia is further defined by segments representing months of the year with each segment presenting sequential numbers representing the thirty-one or thirty days of the calendar month. A second disk has week day indicia printed thereon uniformly spaced along the periphery thereof, in a sequential pattern and a marker printed thereon. The position of the marker next to any given day indicia on the first disc as both disks are rotatable next to one another will indicate a day of a future event indicated on the first disk within the segment as the user will identify number of weeks counted from the marker.

### RELATED APPLICATIONS

This is a non-provisional application that claims priority to a provisional application Ser. No. 61/795,361 filed on Oct. 15, 2012 and incorporated herewith by reference in its entirety.

### FIELD OF THE INVENTION

The present invention relates to a piece of jewelry, and more particularly to a wrist watch.

### BACKGROUND OF THE INVENTION

People have been using calendars for centuries to plan different events, meetings, and other gatherings. Different social and business events are usually planned with great care and well in advance. Most often these events are planned without reference to a calendar. In today's very complicated social and business climate, such dates must be planned often months and even years in advance.

Unfortunately, conventional calendars ordinarily span but a single year. There are calendars that show multiple years. However, those calendars which show multiple years are usually printed in three or four whole year calendar formats and side-by-side, as is frequently the case with check-book recording forms that are issued by bands. There is a wide range of calendars on the market, including a perpetual calendar that displays the month, day and date by the turn of a dial; however, it does not have the year included in its design.

U.S. Pat. No. 5,189,285 to Fletcher Young, Jr. for example, teaches a calendar date finder in the form of a circular slide rule composed of two interacting disks, rotation of one disk relative to the other selectively providing calendar date information from a first preselected year through a second preselected year, inclusive. An upper disk has a circular periphery with a notch along a portion thereof, and further has a cut-out spaced uniformly from the periphery and extending along a portion of the periphery. Numeric indicia are printed on the upper disk adjacent the notch. The numeric indicia are sequential numbers from 1 to 31 representing the thirty-one days of a calendar month. Month indicia are printed on the upper disk in a predetermined pattern adjacent the cut-out. A lower disk has week day indicia printed thereon uniformly spaced along the periphery thereof, in a sequential pattern. Spaced inwardly from the week day indicia is a predetermined pattern of year indicia indicating each year from the first through the second preselected years, inclusive. The position of the year indicia is such as to show through the cut-out, and the position of the week day indicia is such as to show through the notch. Alignment of a month indicia with a year indicia automatically indicates the days of the week for dates in that month in that year. This date finder can be carried in the bag. In reality, there is a great chance that this date finder can be lost, stolen or simply forgotten by the user.

Numerous reminder type devices were used in the form that will allow the user to wear these reminder type devices. For example, U.S. Pat. No. 7,035,169 to Gonzales teaches an electronic timepiece, of the wristwatch type, for providing information relating to an event comprising a plurality of scheduled events, like for example the Olympic Games, the football World Cup, or the public holidays across the world. The timepiece includes in particular a control circuit comprising storage means in which there is stored data relating to the scheduling of the plurality of scheduled events and comparison means for comparing the data stored with a time-related piece of information, the control circuit activating indicator means for designating one or more events in response to a control signal from comparison means. To the extent effective for one purpose such as providing information relating to the events like for example the Olympic Games, the football World Cup, or the public holidays across the world, this electronic timepiece has a limited purpose and is not configured to provide day finder functions.

Another prior art reference, namely U.S. Pat. No. 5,199,009 to Svast, teaches a programmable clock that includes a memory for storing times, dates and messages for subsequent read-out and display in providing a reminder of a birthday, anniversary, doctor's appointment, meeting, etc. The clock is adapted for prominent display by mounting to a wall or other support structure and provides a user with a visual display of stored reminder messages, as well as an indication of the content of the reminder message, over a given future time period, i.e., all stored reminder messages for today, tomorrow, or some other selected day in the future. The reminder clock also includes a speaker and an audio recorder for providing a reminder message in the user's own voice, as well as a printer for providing more extensive reminder messages as well as a list of all stored reminder messages. The reminder clock makes use of any one of several analog and combined analog and digital time displays which are easily read and understood, including a display presenting an analog representation of hours and a digital display of minutes. Various audio and/or video alarms are provided to indicate the read-out and display of a reminder message. An electronic pendulum is provided to indicate proper operation of the reminder clock as is a calendar indicating the days and times when stored reminder messages are to be recalled from memory and displayed. To the extent effective for one purpose, this reminder clock cannot be worn by the user and is very complicated in production.

Sports fans desire easy access to information such as the location, participants, and date and time of sporting events. Conventional sources of such information include periodicals, television and radio broadcasts, and team schedule cards. Periodicals and broadcasts provide inadequate information delivery for various reasons. A typical sports page or news broadcast covers only the events of the preceding day, the current day, and the following day, leaving the fan unable to plan for future events. The fan must repeatedly consult these sources by purchasing additional periodicals or watching subsequent broadcasts. Also, the information content is over-inclusive from the perspective of a focused sports enthusiast. Periodicals and broadcasts provide information on all participants of a variety of sports. Much of this information is irrelevant to a fan interested in the schedule of a single participant. Moreover, the information has poor portability characteristics. Intact periodicals are bulky. Disassembled periodicals, such as individual newspaper

Still another prior art reference, such as U.S. Pat. No. 6,414,907 to Pennington, teaches a portable electronic device for displaying daily schedule information of a particular event and selectively displaying past and future schedule information which includes a display controlled by a processor having an internal programmable memory. The schedule information includes the location of the event, the start time, and the corresponding time zone. The memory contains data representing the event's schedule and a program for controlling the processor. The display provides actual time and date information and schedule information corresponding to the displayed calendar day. By manipulating a plurality of externally mounted push-button switches, the user commands the processor to update the display with schedule information corresponding to past and future days. A programmable alarm provides an audible reminder when a scheduled event begins. The portable electronic device of U.S. Pat. No. 6,414,907 to Pennington is complicated in production, relies on a battery, may malfunction when the battery is dead, and rely on the processor having the internal programmable memory.

Therefore, an opportunity exists for an improved watch device that will be easy to manufacture and use, will offer features and functions not realized by the prior art devices, and will eliminate any disadvantages associated with the prior art devices.

### SUMMARY OF THE INVENTION

An inventive apparatus presents a watch with a calendar date finder device integrated thereon. A watch of the present invention includes a housing and a bracelet to be worn by a user. The housing includes a peripheral wall and a front surface with a plurality of arrows such as a minute arrow, a hour arrow, and a second arrow connected thereto and extending through a plurality of gears meshingly engaged with one another to move the arrows around a front plate presenting indicia of hours and minutes to indicate time of a day. The arrows extend through and are positioned above the front plate and are movable around a central axis to identify a time of a day.

A first disk is mechanically engaged with the housing and has a first side and a first periphery. The first disk presents a month indicia placed on the first side of the first disk. The month indicia is arranged in a separate sequential pattern divided into segments each representing a month, i.e. January through December. Each segment presents a sequence of numbers from 1 to 31 to indicate days of the month. The first periphery of the first disk presents a circular configuration and a plurality of cut our portions thereby defining the segments between one another into twelve segments representing twelve months with each of the segments presenting the sequence of numbers from 1 to 31 within the segments of the months that have 31 days and number from 1 to 30 within the segments of the month that have 30 days.

A second disk presents a second side and a second periphery. The second disk presents indicia representing weeks placed on the second side of the second disk at a location adjacent the second periphery. The week day indicia is arranged in ascending order from 1 to 52 thereby indicating weeks of the year. A marker element is imprinted on the second side of the second disk. The marker element is raised above the second side of the second disk to form a raised portion engaged by the user in order to rotate the second disk relative the first disk. Alternatively, the marker element may be embedded in the second side of the second disk thereby being coplanar with the second disk. The first disk and said second disk are fabricated from metal and metal alloys. Alternatively, the first disk and the second disk are fabricated from polymeric material. The second periphery includes a track defined around the second periphery having male or female connectors to mechanically engage with male or female connectors of a driving gear located inside the housing and movable by a knob as the user rotates the knob around a knob axis B to move the second disk relative the first disk in order to place the marker element where the used desires.

The first and second disks are movable relative to one another thereby allowing the user to determine a day of a future event by rotating the second disk to place the marker adjacent the number indicating a present day within the segment indicating a present month as the day of the future event to be determined will be located on the first disk within the segment indicating the month and the day within that particular month wherein the day of the month will appear adjacent the number of the last week. Automatically, the numeric indicia indicating the day of the month will be correctly aligned with respect to the last week indicia presented on the second disk.

Accordingly, it is an object of the present invention to provide a watch with a calendar date finding device incorporated thereon which can provide calendar date information for any year.

Another object of the present invention to provide an inventive watch with a calendar date finding device which can provide calendar date information for any year through a pair of discs, which are rotated relative to one another so as to align indicia printed thereon.

Still another object of the present invention to provide an inventive watch with a calendar date finding device which can provide a whole month of calendar date information being provided simultaneously.

It is an object of the invention to provide improved elements and arrangements thereof in an apparatus for the purposes described which is inexpensive, dependable and fully effective in accomplishing its intended purposes.

Other objects, features, and advantages of the present invention will become apparent upon consideration of the following detailed description of a preferred embodiment thereof, when taken in conjunction with the appended drawing.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a front view of a wrist watch with a day finder device (the device) integrated thereon;

FIG. 2 illustrates an enlarged view of the device as shown in FIG. 1;

FIG. 3 illustrates a cross sectional view of the device taken along lines 3-3 of FIG. 1; and

FIG. 4 illustrates an alternative embodiment of the device of the present invention.

### DESCRIPTION OF THE INVENTION

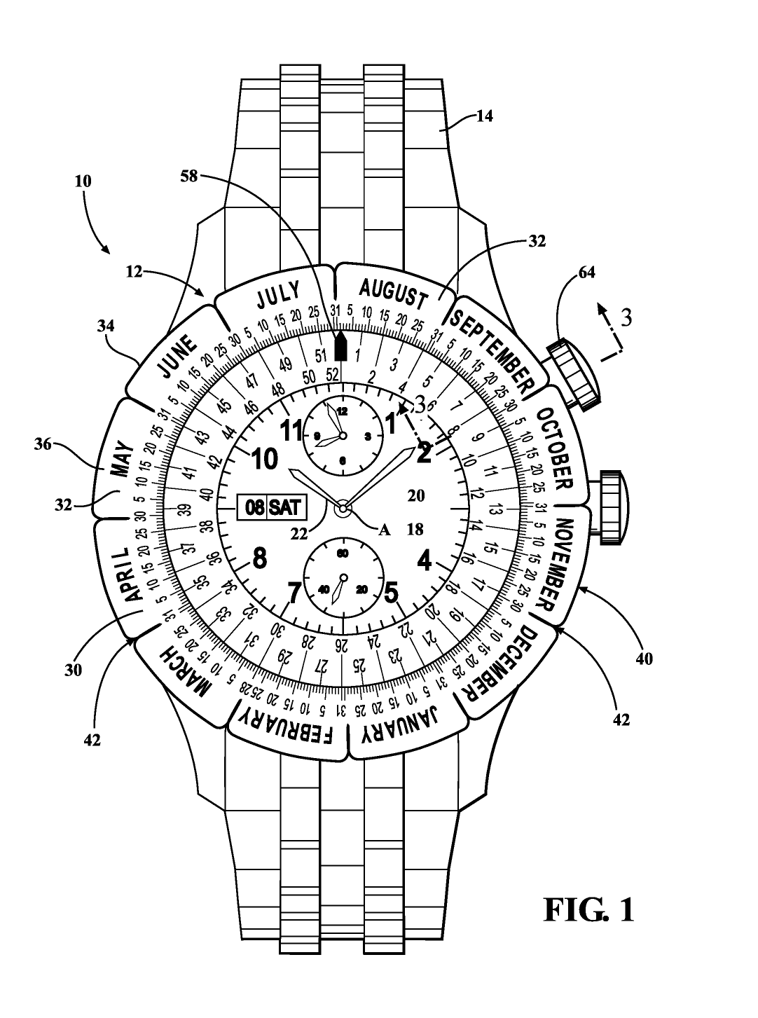

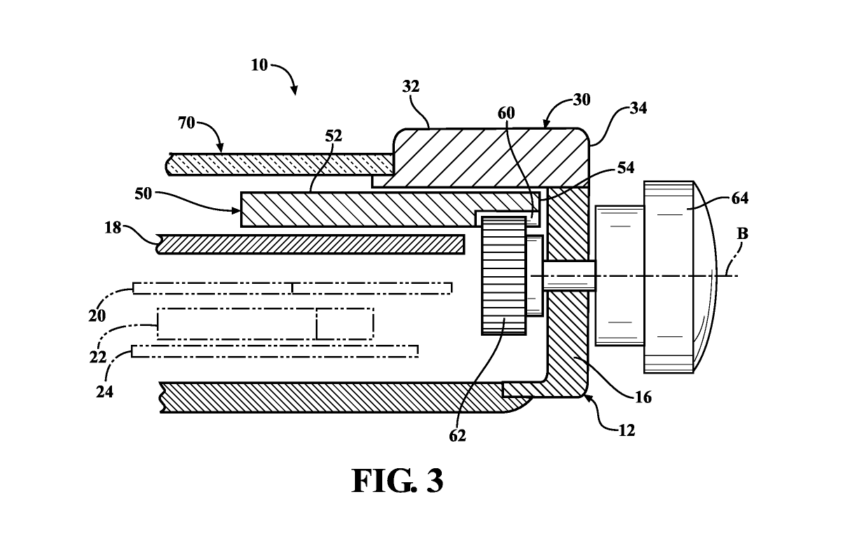

Referring to FIGS. 1 through 3, wherein like numerals indicate like or corresponding parts throughout the several views, an apparatus of the present invention such as a watch is generally shown at 10. As shown in FIGS. 1 through 3, the watch 10 of the present invention includes a housing, generally indicated at 12, and a bracelet 14 to be worn by a user (not shown). As best shown in FIG. 3, the housing 12 includes a peripheral wall 16 and a front surface or plate 18 with a plurality of arrows such as a minute arrow 20, a hour arrow 22, and a second arrow 24 connected thereto and extending through a plurality of gears (not shown) meshingly engaged with one another to move the arrows 20 through 24 around the front plate 18 presenting indicia of hours 26 and minutes 28 to indicate time of a day. The arrows 20 through 24 extend through and are positioned above the front plate 18 and are movable around a central axis A to identify a time of a day.

A first disk, is generally indicated at 30, is mechanically engaged with the housing 12 and has a first side 32 and a first periphery 34. The first disk 30 presents a month indicia 36 placed on the first side 32 of the first disk 30. The month indicia 36 is arranged in a separate sequential pattern divided into segments (only one is generally indicated at 40) wherein each segment 40 represents a month of the year, i.e. January through December. Each segment 40 presents a sequence of numbers from 1 to 31 or 1 to 30 to indicate days of the given month. The first periphery 34 of the first disk 30 presents a circular configuration and a plurality of cut out portions (only one in generally indicated at 42) thereby defining the segments 40 between one another into twelve segments. The sequence of numbers from 1 to 31 or 1 to 30 indicates days of the given month extending from an inner edge, generally indicated at 44, of the first disk 30.

Alluding to the above, the first disk 30 may also present the peripheral edge 34 formed in different geometrical shapes. The circular configuration of the first disk 30 as illustrated in FIGS. 1 through 3 is not intended to limit the scope of the present invention. The first disk 30 may be fabricated by injection molding and stamping processes from polymeric materials, metals, and metal alloys without limiting the scope of the present invention. The numbers from 1 to 31 or 1 to 30 to indicate days of the given month and the month indicia 36 may be coined into the first side 32 or printed thereon in different colors and styles. Alternatively, the numbers from 1 to 31 or 1 to 30 to indicate days of the given month and the month indicia 36 may be formed from any material, such as phosphorus to be visible in the dark.

A second disk is generally indicated at 50 in FIGS. 1 through 3. The second disk 50 presents a second side 52 and a second periphery 54. The second disk 50 presents indicia, generally indicated at 56, representing 52 weeks of the year placed on the second side 52 of the second disk 50 at a location adjacent the second periphery 54. The week day indicia 56 is arranged in ascending order from 1 to 52 thereby indicating weeks of the year. A marker element 58 is imprinted on the second side 52 of the second disk 50. The second periphery 54 includes a track 60 defined around the second periphery 54 having male or female connectors to mechanically engage with male or female connectors of a driving gear 62 located inside the housing 16 and movable by a knob 64 as the user rotates the knob 64 around a knob axis B to move the second disk 50 relative the first disk 30 in order to place the marker element 58 where the user desires.

Alternatively, the marker element 58 is raised above the second side 52 of the second disk 50 to form a raised portion (not shown) to be engaged, i.e. touched by the user in order to rotate the second disk 50 relative the first disk 30. Alternatively, the marker element 58 may be embedded in the second side 52 of the second disk 50 thereby being coplanar with the second disk 50. The second disk 50 may be fabricated by injection molding and stamping processes from polymeric materials, metals, and metal alloys without limiting the scope of the present invention. The numbers from 1 to 52 indicating numbers of weeks per year may be coined into the second side 52 or printed thereon in different colors and styles. Alternatively, the numbers from 1 to 52 may be formed from any material, such as phosphorus to be visible in the dark. A glass plate 70 encloses the central portion of the watch 10 to prevent debris, water, and other foreign object from entering into the watch 10.

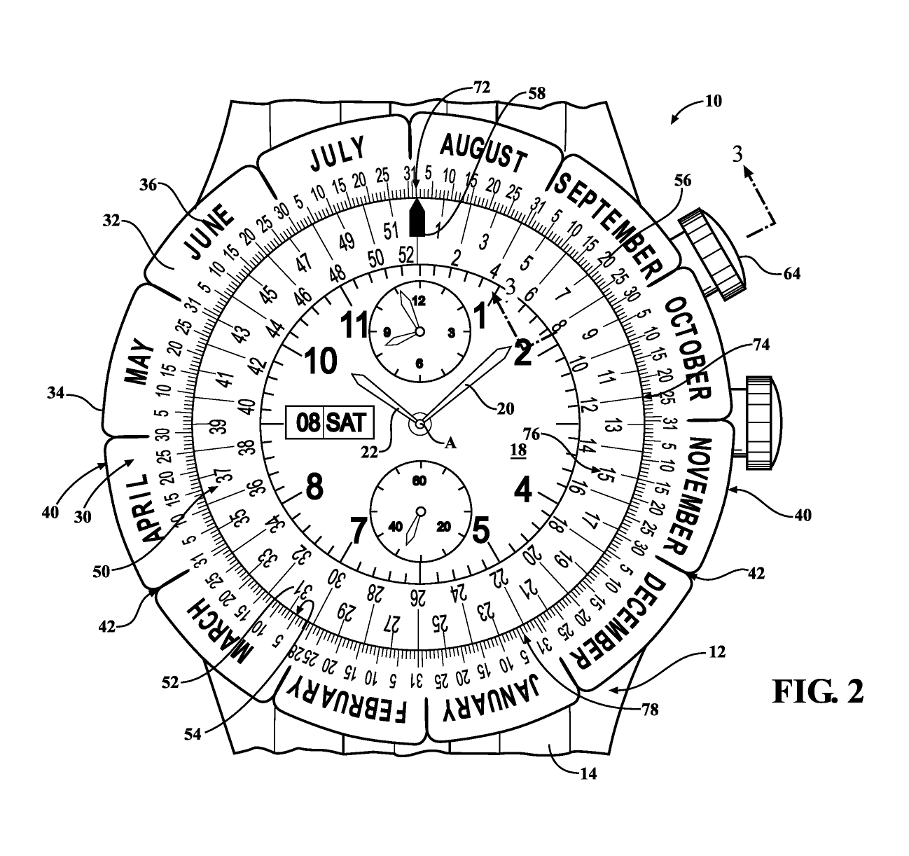

The first 30 and second 50 disks are movable relative to one another thereby allowing the user to determine a day of a future event by rotating the second disk 50 to place the marker element 58 adjacent the number indicating a present day within the segment 40 indicating a present month. For example, as best shown on FIG. 2, the user has a meeting on August 1, as generally indicated at 72. If the user needs to arrange next meeting in 12 weeks from August 1, the user needs to locate number “12” at the week indicia located on the second side 52. The number “12” will be adjacent to October 25, which is located within one of the month segments 40 on the first disk 30. Here, the day of the future event will take place on October 25, as generally indicated at 74. Now the user wants to plan to have another meeting on November 15, as generally indicated at 76, and wants to know in advance when his next meeting will take place after seven weeks from November 15. The user will rotate the knob 64 around the knob axis B to move the second disk 50 relative the first disk 30 in order to place the marker element 58 at a below the segment 40 that indicates “November” and below the number “15”. As the user will look at week number “7”, the user will see that the week number “7” is aligned below the segment 40 that indicates “January” and below the number “1”, as shown at 78. Automatically, the numeric indicia indicating the day of the month as it appears on the first disk 30 will be correctly aligned with respect to the selected week indicia presented on the second disk 50.

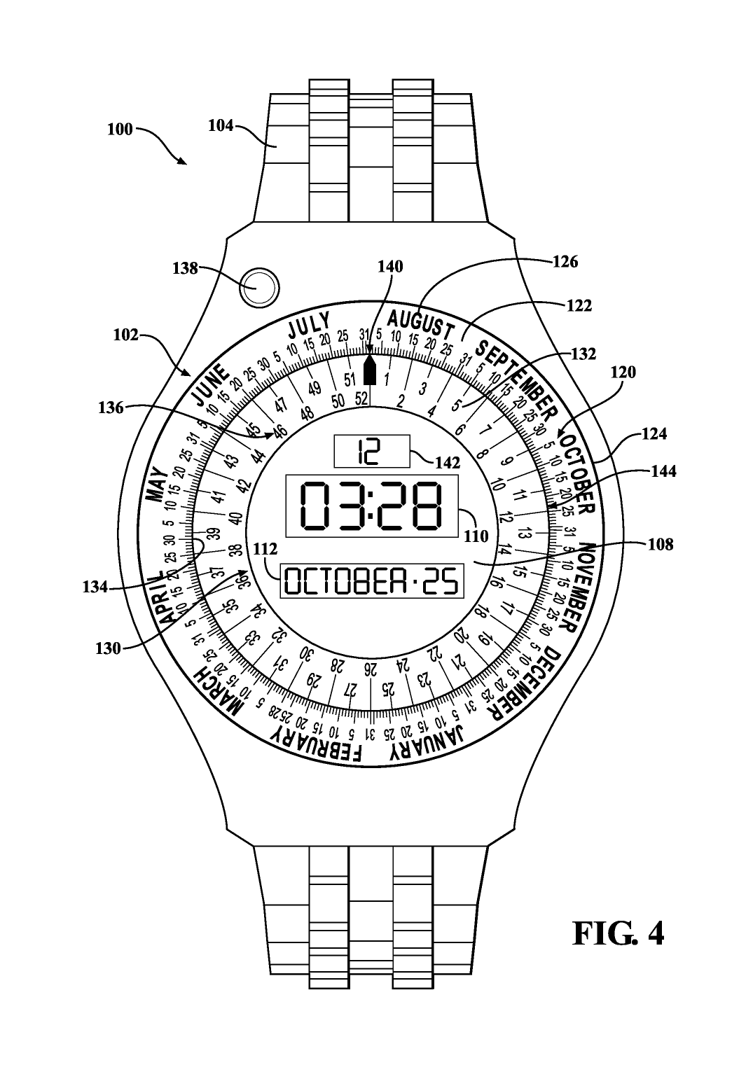

FIG. 4 illustrates an alternative embodiment of the watch generally shown at 100, available in electronic version. The watch 100 includes a housing, generally indicated at 102, and a bracelet 104 to be worn by a user (not shown). The housing 102 includes a front surface or plate 108 with a plurality of screens such as a time screen 110 and a future date screen 112.

A first disk, is generally indicated at 120, is presented in electronic version. The first disk 120 has a first side 122 and a first periphery 124. The first disk 120 presents a month indicia 126 placed on the first side 122 of the first disk 120. The month indicia 126 is arranged in a pattern that represents a month of the year, i.e. January through December. Each month presents a sequence of numbers from 1 to 31 or 1 to 30 to indicate days of the given month.

Similar to the first disk 120, a second disk is generally indicated at 130. The second disk 130 presents a second side 132 and a second periphery 134. The second disk 130 presents indicia, generally indicated at 136, representing 52 weeks of the year placed on the second side 132 of the second disk 130 at a location adjacent the second periphery 124. The week day indicia 136 is arranged in ascending order from 1 to 52 thereby indicating weeks of the year. A marker element 136 is imprinted on the second side 132 of the second disk 130. A button 138 is located on the housing 102.

For example, let's say that the user has a meeting on August 1, as generally indicated at 140. If the user needs to arrange next meeting in 12 weeks from August 1, the user will push the button 138 until number “12” will show up in an upper screen 142. The user needs to locate number “12” at the week indicia located on the second side 52. Here, the day of the future event will take place on October 25, and will be displayed on the screen 112. Many other designs of the electronic version of the watch 110 may be available without limiting the scope of the present invention. For example, the watch 100 may have a voice activation device where the user will speak the current date and number of weeks when the next event will take place as the screen 112 will display such future event.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A watch having a bracelet to be worn by a user, said watch comprising:
a housing having a peripheral wall and a front surface with a plurality of arms connected thereto and movable around a central axis to identify a time of a day;
a first disk engaged with said housing and having a first side and a first periphery and presenting a month indicia placed on said first side of said first disk with said month indicia being arranged in a separate sequential pattern divided into segments each representing a month and presenting a sequence of numbers from 1 to 31;
a second disk presenting a second side and a second periphery and further presenting a week indicia located on said second side of said second disk at a location adjacent said second periphery, said week day indicia being arranged in ascending order and a marker element imprinted on said second side of said second disk; and
a mechanical engagement defined between said first and second disks allowing said first and second disks to move relative to one another to automatically determine a day of a future event predetermined by the user by rotating said second disk to place said marker adjacent the number indicating a present day within said segment indicating a present month whereby the day of the future event will be shown in another of said segments by one of said sequence of numbers and adjacent the last number of the week that appears on said second disk.

2. A watch as set forth in claim 1, wherein said first and second disks are coplanar with respect to one another.

3. A watch as set forth in claim 2, wherein said first disk is raised above said second disk.

4. A watch as set forth in claim 3, wherein said second disk is raised above said first disk.

5. A watch as set forth in claim 4, wherein said first periphery of said first disk presents a circular configuration and a plurality of cut our portions thereby defining said segments between one another into twelve segments representing twelve months with each of said segments presenting said sequence of numbers from 1 to 31 within said segments of the months that have 31 days and number from 1 to 30 within said segments of the month that have 30 days.

6. A watch as set forth in claim 1, wherein said first disk and said second disk are fabricated from metal and metal alloys.

7. A watch as set forth in claim 1, wherein said first disk and said second disk are fabricated from polymeric material.

8. A watch as set forth in claim 1, wherein said marker is raised above said second side of said second disk to form a raised portion engaged by the user in order to rotate said second disk relative said first disk.

9. A watch as set forth in claim 1, wherein said marker is embedded in said second side of said second disk being coplanar with said second disk.

10. A watch as set forth in claim 1, wherein said housing includes a front surface with a plurality of arrows such as a minute arrow, a hour arrow, and a second arrow connected thereto and extending through a plurality of gears meshingly engaged with one another to move said arrows around said front surface presenting indicia of hours and minutes to indicate time of a day.

11. A watch as set forth in claim 1, wherein said mechanical engagement is further defined by a track formed around said second periphery having at least one of male and female connectors.

12. A watch as set forth in claim 11, wherein said mechanical engagement is further defined a driving gear presenting at least one of male and female connectors to mechanically engage with said connectors of said track thereby moving said second disk about said first disk as the user rotates said knob around a knob axis to place said marker element around said first disk.

13. A watch having a bracelet to be worn by a user, a housing having a peripheral wall and a front surface with a plurality of arms connected thereto and movable around a central axis to identify a time of a day, said watch comprising:
a first disk mechanically engaged with said housing and having a first side and a first periphery and presenting a month indicia placed on said first side of said first disk at with said month indicia being arranged in a separate sequential pattern divided into segments each representing a month with each of said segments presenting a sequence of numbers from 1 to 31;
a second disk presenting a second side and a second periphery and further presenting week indicia placed on said second side of said second disk at a location adjacent said second periphery, said week day indicia being arranged in ascending order and a marker element imprinted on said second side of said second disk; and
a mechanical engagement defined between said first and second disks allowing said first and second disks to move relative to one another to automatically determine a day of a future event predetermined by the user by rotating said second disk to place said marker adjacent the number indicating a present day within said segment indicating a present month whereby the day of the future event will be shown in another of said segments by one of said sequence of numbers and adjacent the last number of the week that appears on said second disk.

14. A watch as set forth in claim 13, wherein said marker is raised above said second side of said second disk to form a raised portion engaged by the user in order to rotate said second disk relative said first disk.

15. A watch as set forth in claim 13, wherein said marker is embedded in said second side of said second disk being coplanar with said second disk.

16. A watch as set forth in claim 13, wherein said mechanical engagement is further defined by a track formed around said second periphery having at least one of male and female connectors.

17. A watch as set forth in claim 13, wherein said mechanical engagement is further defined a driving gear presenting at least one of male and female connectors to mechanically engage with said connectors of said track thereby moving said second disk about said first disk as the user rotates said knob around a knob axis to place said marker element around said first disk.
